(19) United States
(12) Patent Application Publication
(10) Pub. No.: US 2008/0066734 A1
(43) Pub. Date: Mar. 20, 2008

(54) GRILL AND METHOD FOR MAKING AND USING THE IMPROVED GRILL

(76) Inventor: Ed Bright, Amarillo, TX (US)

Correspondence Address: JOE;HERBERT, SUITE 1009, 1801 CRYSTAL DRIVE, ARLINGTON, VA, 22202, US

(21) Appl. No.: 11/533,486

(22) Filed: Sep. 20, 2006

(51) Int. Cl. A47J 37/00

(52) U.S. Cl. 126/25 R

(57) ABSTRACT

The present invention is a multi-purpose grill in which one side has holes for the placement of vegetables, especially stuffed or non-stuffed jalapeno or bell peppers, such that when they are grilled or cooked, they do not slip or fall through the holes of various diameters. Such holes do not have smooth edges but jagged edges because the holes are specifically made with a plasma torch. These jagged edges claw in to the vegetables to keep them from falling through the holes, even as they shrink in size due to cooking. The other side of the grill is configured to hold skewers or to place other foods on the grill to cook. Because of the design of the grill, the foods, regardless of which side is used, are cooked evenly without burning or scorching the foods.

### BACKGROUND OF THE INVENTION

1. Field of the Invention

The present invention relates generally to a cooking devices particularly to those used in open fire or equivalent grilling.

2. Background Information

Culinary techniques have improved since time immemorial, from before the introduction of earthenware to beyond the revolutionary microwave oven. As such, the preparation of food and instruments used thereof have yielded a plethora of useful developments and innovations. As these various instruments evolved, they each seemed to have a direct or indirect impact on the taste and flavor of the final product. One recent change has seen the popularity of outdoor vegetable or jalapeno grills.

The flavor of vegetables is enhanced when they are grilled. Because a lot of the moisture evaporates from the vegetables during the grilling process, the flavor becomes more concentrated and the sugars become more condensed which, in turn, increases the sweetness and flavor of the vegetables. For example, grilling accentuates the sweetness and natural flavor of jalapenos and peppers.

However, when smaller-sized vegetables are grilled, they typically are grilled within some sort of grilling basket to keep them out of the fire, as these smaller vegetables can slip through the grill grid. In fact, when vegetables, e.g., jalapenos, are cooked, their sizes change and as such, they can fall through the grill slit or customized holes within a grill.

Also, for the many vegetables that are chosen to be cut so that they can be stuffed and then cooked are not easily prepared on a typical grill, as these may be unevenly cooked or can fall apart during the cooking process, as their sizes change during cooking. Or, at the least, they need to be timely turned, which increases the chances of evenly cooking the food improperly, or the food spilling or falling apart during the turning.

Presently sold vegetable or jalapeno grills have uniformly sized holes or shapes, and no special edges on the holes or shapes to keep the vegetables or jalapenos from slipping or falling through as they are being cooked. Also, commercial grills do not function well as a rack for cooking or grilling meats or skewers of food.

It is desirable to have a grill that can keep jalapenos, bell peppers and other vegetables in place during grilling, or during cooking via any controllable heat source, and cook the vegetables evenly.

It is also desirable to have such a grill that can also serve as a rack for meat or for skewers of food.

### SUMMARY OF THE INVENTION

It is an object of the present invention to overcome the foregoing disadvantages and limitations of the prior art.

In view of the preceding, it is an object of this present invention to provide a grill to evenly cook vegetables, especially jalapeno and bell peppers, from any controlled heat source.

It is another object of the present invention to provide a grill to evenly cook meats or skewers of food from any controlled heat source.

It is another object of the present invention to provide a grill that does not scorch or burn jalapeno and bell peppers during the cooking or grilling process.

It is another object of the present invention to provide a grill in which the holes for the vegetables have a jagged edge produced from a plasma torch to prevent slippage during cooking.

It is another object of the present invention to provide a grill in which the holes for the vegetables have a jagged edge that will hold the vegetable during the cooking process even if the vegetable shrinks in size.

It is another object of the present invention to provide a grill in which there are slots to lay skewers of food.

In satisfaction of these and related objectives, the present invention is a unique grill designed to either evenly cook or grill 1) vegetables, especially jalapeno and bell peppers, or similarly shaped vegetables, whether stuffed or not, and to hold such vegetables as they shrink in size during the cooking process, or 2) meats or skewers of food.

The improved grill of present invention can cook vegetables, especially bell peppers and jalapeno peppers, in any controlled heat source, including a conventional oven, a barbeque pit, a broiler oven, an infrared oven, a smoke pit or a campfire using a rack.

When a jalapeno heats up during cooking, as with any other vegetable, it will decrease in size primarily because of moisture loss. If the shrinkage is significant enough, as is often the case, then the vegetable will fall through the hole that was initially holding it. Furthermore, to exacerbate this problem, the holes in which the vegetables, e.g., jalapenos, are set in a typical grill are smooth because they are made with a water saw and or a drill press.

The holes of the grill of the present invention are made with a plasma torch. Unlike a water saw or a drill press, the plasma torch produces holes with a jagged edge. This jagged edge effectively “bites” the vegetable, e.g., jalapeno pr bell pepper, and keeps it from falling thru the holes during the cooking process. This, in turn, not only keeps the vegetable from falling though the grill even as it shrinks in size during the cooking process, but it also provides an evenly distributed cooking environment that prevents the age-old problem of scorching, burning or uneven cooking of the vegetable.

When the grill is inverted, it can be used as a rack with slots on the bottom to hold K-bob skewers of foods. Because of the spacing of the slots for the skewers, cooking of the foods on the skewers is even. The grill can also be used to cook most any other foods, e.g., dove, quail, Cornish game hens, tomatoes, onions, artichokes or apples, along with the bell peppers or jalapeno peppers. Any of these or similar foods can be cooked in approximately 15 minutes (depending mainly on amount of heat and uncooked foods present).

After removing any of the above foods from the oven, stuffed jalapeno peppers, for example, can be placed in the jalapeno holes, then the entire racked filled with foods is replaced back in the controlled heat source, e.g., oven, and cooked for another 15 minutes (depending mainly on amount of heat and uncooked foods present).

### BRIEF DESCRIPTION OF THE DRAWING

The following drawings are illustrative of the invention and are not meant to limit the scope of the invention as encompassed by the claims:

FIG. 1 is a perspective, upper surface view of the improved grill of the present invention.

FIG. 2 is a top plan view of the grill of FIG. 2, particularly showing the cooking plate portion thereof.

FIG. 3 is a rear elevational view of the grill of the present invention.

FIG. 4 is a front elevational view of the grill of the present invention.

FIG. 5 is a perspective, lower surface view of the improved grill of the present invention, showing a skewer engaged with a corresponding pair the skewer notches provided in the grill and skewer support members.

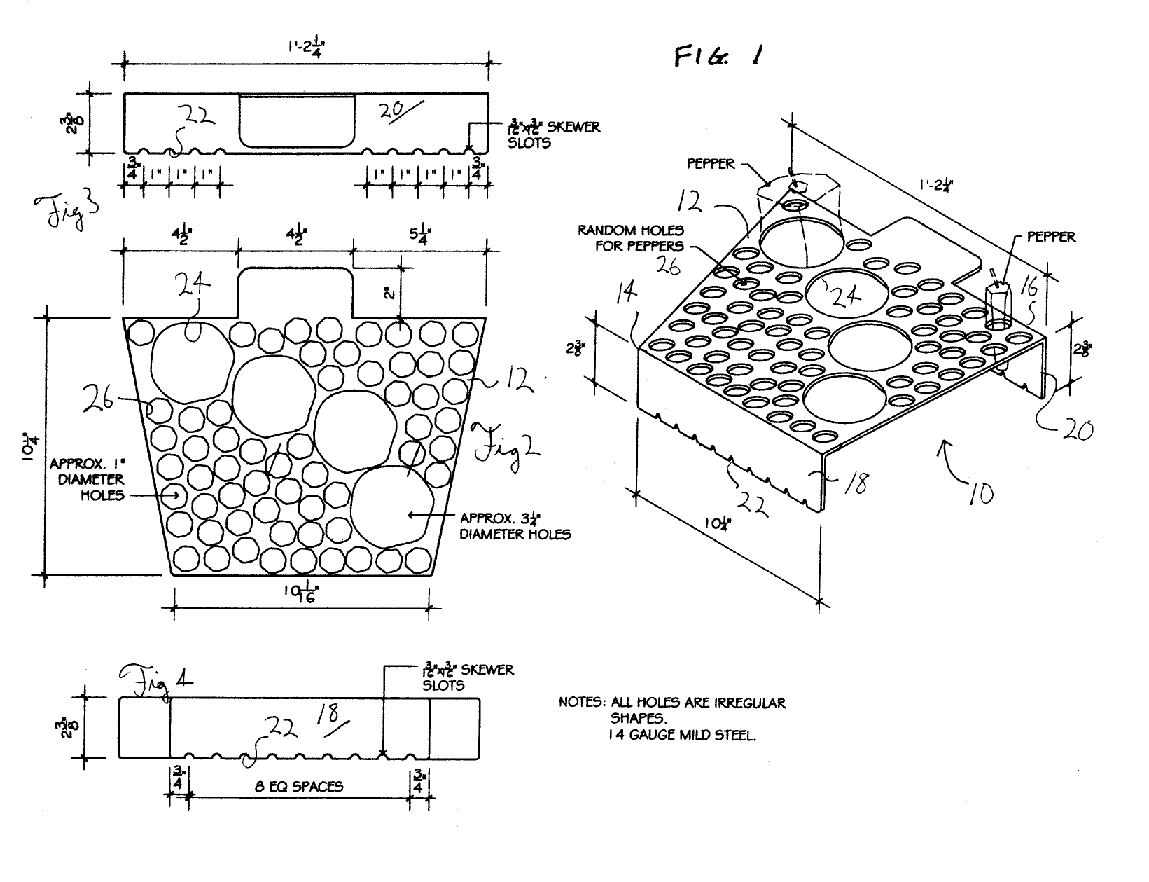

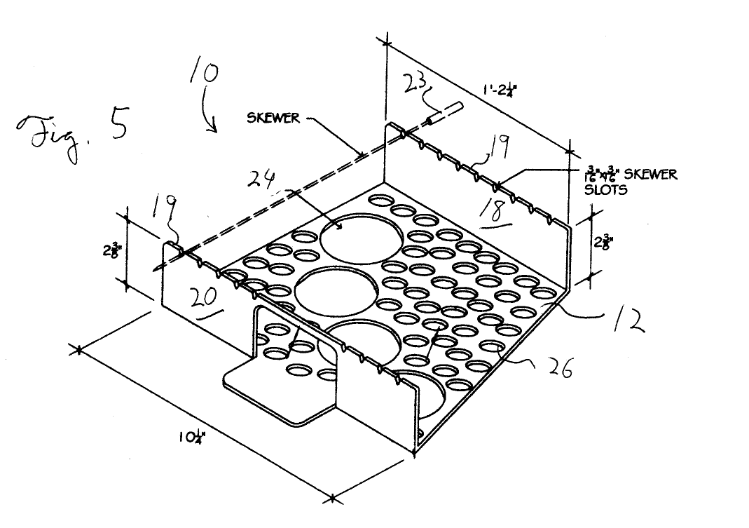

### DETAILED DESCRIPTION OF THE PREFERRED EMBODIMENT

In the preferred embodiment, the grill 10 is constructed of 14 gauge mild steel. A cooking plate 12, having front and rear “faces” is, in the preferred embodiment, trapezoidal with a forward edge 14 having a length of approximately 10¼″, a rearward edge 16 having a length of approximately 14¼″, and an over-all depth of approximately 10″. Of course, alternative embodiments of the present invention may be rectangular, or even of shapes having more than four margins.

First and second grill and skewer support members 18 and 20 are each approximately 2⅜″ in height and, in the preferred embodiment, extend at right angles, respectively, from the forward cooking plate margin 14 and rearward cooking plate margin 16 of cooking plate 12.

Both grill and skewer support members 18 and 20 include distal support margins 19, each having corresponding skewer notches 22, which support skewers 23 (one is shown in FIG. 5) at their respective proximal and distal ends, or vice versa. Because of the differing lengths of grill and skewer support members 18 and 20, skewer notches 22 are spaced such that skewers engaged therewith assume something of a partial, radial arrangement, when used with a trapezoidal shaped cooking plate 12, as shown in the drawings.

In the preferred embodiment, cooking plate 12 includes several—3¼″ holes 24, and a number of smaller holes 26, ranging approximately between ¾″ to 1½″, depending on the particular items for which the grill 10 is intended to be used. When intended for use with cooking jalapeño and similarly sized peppers, the smaller holes 26 will have a diameter roughly in the 1″ range. Of course, variations of the present grill 1 0 may include nothing but “larger” or “smaller” holes, depending on the intended use of the grill 10.

More important than hole diameter itself (although the diameter should be appropriate to the items expected to be cooked), the margin of each hole 24 or 26 will be irregular, or “jagged”, as mentioned earlier. This serves to reduce the chances of an item falling from grill 10 into a fire or other heat source as the various protrusions of each hole's margin serve as “teeth” to engage the flesh of the vegetable.

The present inventor has determined that, rather than tediously cut holes 24 or 26 in cooking plate 12, following that which ordinarily would be an intended, irregular cutting path, use of a plasma torch “automatically” produces the desired irregular hole margin.

When using grill 10, bell peppers, quail, tomatoes, Cornish game hens, and the like (slower cooking items) are placed in appropriate holes 24 or 26 first. After a cooking time of approximately 18 minutes (depending mainly on amount of heat and uncooked foods present), stuffed jalapenos (if any) are added and cooking continues an additional 15 minutes (depending mainly on amount of heat and uncooked foods present). In succession, the entire appetizers will be done at the same time.

The view of FIG. 5,shows grill 10 in its skewer configuration.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An improved grilling apparatus comprising:
a cooking plate formed of heat-resistant sheet material and having first and second oppositely disposed cooking plate faces and a plurality of cooking plate margins;
a first grill and skewer support member, extending in a first direction from a first cooking plate margin of said cooking plate, and having a first distal support member margin;
a second grill and skewer support member extending in said first direction from a second cooking plate margin of said cooking plate, and having a second distal support member margin;
said cooking plate having a plurality of holes formed therethrough, at least some of said holes having an irregular margin.

2. The grilling apparatus of claim 1 wherein each of said first and second grill and skewer support members has at least one skewer notch for respectively supporting a skewer rod member at proximal and distal ends thereof.

3. The grilling apparatus of claim 1 wherein said plurality of holes are formed through use of cutting torch means.

4. The grilling apparatus of claim 2 wherein said plurality of holes are formed through use of cutting torch means.

5. A method of grilling food items comprising the steps of:
selecting an improved grilling apparatus comprising:
a cooking plate formed of heat-resistant sheet material and having first and second oppositely disposed cooking plate faces and a plurality of cooking plate margins;
a first grill and skewer support member, extending in a first direction from a first cooking plate margin of said cooking plate, and having a first distal support member margin;
a second grill and skewer support member extending in said first direction from a second cooking plate margin of said cooking plate, and having a second distal support member margin;
said cooking plate having a plurality of holes formed therethrough, at least some of said holes having an irregular margin;
engaging a plurality of to-be-cooked items with a like plurality of said holes; and
placing said improved grilling apparatus is proximity of a heat source for cooking said to-be-cooked items.

6. The method of claim 5 wherein each of said first and second grill and skewer support members has at least one skewer notch for respectively supporting a skewer rod member at proximal and distal ends thereof.

7. The grilling apparatus of claim 5 wherein said plurality of holes are formed through use of cutting torch means.
